(19) United States
(12) Patent Application Publication
(10) Pub. No.: US 2013/0027279 A1
(43) Pub. Date: Jan. 31, 2013

(54) COLOR DISPLAY SYSTEM

(71) Applicant: Robert Herman Peacock, Akron, OH (US)

(72) Inventor: Robert Herman Peacock, Akron, OH (US)

(21) Appl. No.: 13/191,837

(22) Filed: Jul. 27, 2011

(51) Int. Cl. G09G 5/00

(52) U.S. Cl. 345/1.3

(57) ABSTRACT

A high-visibility display system includes two or more sign sections with each sign section being supplied with display data by a single computer transmitting the display data concurrently.

### TECHNICAL FIELD OF THE INVENTION

The present invention relates to electronic sign displays, and more particularly, to large-scale color LED displays intended for airborne or long-distance viewing relative to the observer thereof.

### BACKGROUND

Many types of conventional matrix display signs have been developed for a wide variety of applications. Some of these conventional signs are even capable of displaying full color motion video. These signs are quite common, appearing as flashing message boards on roadways, informational signs on buildings and in shop windows, on billboards, at ball parks and arenas, and even on the sides of airships, such as the Goodyear Blimp.

Conventional matrix signs may be made up of a plurality of “pixels” or picture elements. These pixels are arranged in a two dimensional array and their optical characteristics (e.g., brightness or reflectivity) are individually controlled so that the overall appearance is that of a complete two-dimensional image. For large-scale signs, arrays of light emitting diodes (LEDs) have proven to be especially useful and effective. As solid-state devices, LEDs are particularly rugged and are relatively impervious to mechanical shock and vibration. LEDs typically have very long life when properly used (especially when compared to incandescent bulbs, plasma and neon displays, and other luminous devices), and are available in a variety of colors—most importantly red, green and blue, which makes them particularly well suited to constructing multi-color and full-color displays. LED drive circuits may be easily adapted to span a wide range of pixel brightness (intensity), either by controlling the LED's forward current continuously, or via pulse width modulation of a fixed drive current.

Further, LEDs in large scale displays may create large, effective pixel sizes by utilizing clusters of LEDs for each pixel. For example, a smaller color matrix display may employ one red-green-blue (RGB) trio of LEDs for each pixel, while a large display might use a larger number of LEDs per pixel to create a larger effective pixel size. For smaller displays, conventional tri-color RGB LED trios are available in a single standard-size LED package. The LEDs making up a pixel may be driven in series, in parallel, or in series-parallel combinations, providing great flexibility in accommodating different power supply voltages and current drive levels.

Airship signs may present a number of special challenges rarely encountered in other applications. First, airship signs may be deployed on a curved surface—the exterior of a blimp. As a result, the pixels should be placed and aimed carefully to provide a natural and consistent appearance to a viewer on the ground. Second, a sign mounted on the exterior of an airship envelope must also allow the airship envelope to be maintained gas tight and eliminate risks of puncture and/or interference with airflow within the envelope.

Third, viewing distances for airship signs may be much greater than those encountered in other matrix sign applications. Even a billboard-mounted matrix sign or a ballpark matrix sign are typically closer to a viewer than an airship sign. Thus, to be seen comfortably, an airship sign may have very wide pixel spacing and very high brightness compared to other signs of comparable resolution. However, due to the wide pixel spacing, if the pixel size is too small on the airship envelope, each pixel may appear to a viewer as a very tiny, very bright point and will not integrate as well into the appearance of a continuous image, as a larger, more “diffuse” pixel would.

Fourth, in lighter-than-air craft such as blimps, payload weight is always a concern. It may therefore not be feasible to carry huge battery racks, generators, or bulky electronic equipment. The weight of the sign itself also must be considered. Because of the requirement for high brightness, an airborne sign may consume a great deal of power, especially when providing full-color motion video. If the sign merely flashes black-and-white bi-level images and logos, most of the pixels may be completely dark at any given time. With a continuous-tone video, however, especially when there is a bright background, many or all of the pixels may be fully or partly illuminated for extended periods of time, creating a very high current requirement compared to simple text and bi-level image display.

In video applications, “continuous tone” control of brightness and high frame rates (e.g., greater than 30 frames per second, or 30 fps) may be required to provide smooth, visually appealing, realistic motion video. In order to be completely compatible with commercial television standards, the system may require update of whole images thirty times per second or more thereby also requiring high data bandwidth from a video source to the display's pixels.

Display sign images may be maintained in a display buffer memory. A scanning mechanism may rapidly and repeatedly scan the display memory and update pixel intensities according to values stored in the display buffer memory. Assuming that the scanning mechanism is fast enough, an appearance of a relatively flicker-free two-dimensional image may be created. For motion video, however, the data should be scanned from the display buffer memory at a rapid rate, but new image data should also constantly update the contents of the display buffer memory. Further, a mechanism may translate video image data from the video source into a format required by the display buffer memory in real-time. The rate at which the display buffer memory may be updated places limitations on how fast images may be updated on the display sign. Since the display buffer memory may be accessed by both a mechanism that inputs image data and by a mechanism that outputs data, either dual-port memory techniques or other memory sharing mechanisms may be provided to coordinate and synchronize data traffic into and out of the display buffer memory. Since the display buffer memory may be embedded in a display controller acting as a remote peripheral device to a computer or other device acting as a video source, the mechanism by which data is transferred into the display buffer memory may present a significant bottleneck.

As far back as the 1930's, Goodyear has utilized airship signs. First, in 1929, floodlights were used for night illumination. The floodlights illuminated a Goodyear logo painted on the side of the airship's envelope. Then, neon signs were utilized. The first generation was the “NEONOGRAM,” which included a neon tube shaped and formed to allow any letter or numeral to be displayed by distributing current to different segments of the tube. This evolved into incandescent light bulbs with colored lenses, allowing four color static and animated messaging.

The “EagleVision” LED sign, as it is known and installed on Goodyear Blimps, is a 32,768 color LED sign used for day and night advertising, public service messages, and promotional purposes. The sign may be capable of presenting preprogrammed copy, animation, and low resolution video in a fixed (stationary) or moving (any direction) format. As stated above, commercial sign manufactures may build high resolution LED signs, without considering weight and power constraints. A display sign that overcomes weight and power issues to provide a lightweight, power efficient, modular, display sign would be desirable.

One conventional display sign manages power by dividing a display sign into two or more distinct sections and providing power to each section from a separate power source. As a result, the amount of current drawn from any one source may be reduced, thereby reducing required conductor sizes, circuit breaker trip limits, etc. Additionally, in applications where two or more power sources are available, this display sign distributes the power load from the sign across the multiple sources.

This conventional sign may be used for airship-based sign applications (e.g., the Goodyear blimp) wherein a full-color LED sign display may be mounted on an envelope, or outer skin, of a lighter-than-air craft, or blimp. A conventional blimp may have two aircraft engines that generate a limited amount of power. This power may be available for powering the sign, but also may power other on board avionics and electronics.

The conventional sign's computer interface electronics may be operated directly by bus-connected interface circuitry. This may eliminate the need for an external image buffer memory, since the computer's local memory may act as an image buffer. The computer may serially transmit pixel data to a display via the interface mechanism. The display data may be held in shift registers that receive the serial data. When the data for a given section of the sign is completely shifted in, a strobe may be generated to transfer the pixel data to the display. Because of the direct bus-connected nature and direct computer control of the scanning action of the sign's interface circuitry, considerable interface circuitry may be eliminated and data transfer operations may be executed at the full speed of the computer.

### SUMMARY OF THE INVENTION

A high-visibility display system in accordance with the present invention includes two or more sign sections with each sign section being supplied with display data by a single computer transmitting the display data concurrently.

According to another aspect of the present invention, the system further includes a pixel driver interface with an output port for each sign section.

According to still another aspect of the present invention, the pixel driver interface includes a microprocessor for each sign section.

According to yet another aspect of the present invention, the pixel driver interface includes a universal asynchronous receiver/transmitter for each sign section.

According to still another aspect of the present invention, the pixel driver interface includes a RS485 communication module for each sign section.

According to yet another aspect of the present invention, the computer includes a fast parallel output port for playing graphics in a predetermined format.

According to still another aspect of the present invention, the system further includes a plurality of pixel boards, each pixel board comprising one RGB LED cluster.

According to yet another aspect of the present invention, each pixel board comprises 8 pixels.

According to still another aspect of the present invention, each pixel board comprises 8 horizontal pixels.

According to yet another aspect of the present invention, each pixel board comprises a horizontal group of 8 pixels on a single circuit board.

According to yet another aspect of the present invention, each horizontal group of 8 pixels shares mounting hardware, power supply circuitry, and a RS485 receiver.

A high-visibility display sign in accordance with the present invention includes two or more sign sections supplied with display data by a single computer transmitting the display data concurrently to each sign section and a pixel driver interface with an output port for each sign section.

According to another aspect of the present invention, the pixel driver interface includes a microprocessor for each sign section.

According to still another aspect of the present invention, the pixel driver interface includes a universal asynchronous receiver/transmitter for each sign section.

According to yet another aspect of the present invention, the pixel driver interface includes a RS485 communication module for each sign section.

According to still another aspect of the present invention, the computer includes a fast parallel output port for playing graphics in a predetermined format.

According to yet another aspect of the present invention, the system further includes a plurality of pixel boards, each pixel board comprising one RGB LED cluster.

According to still another aspect of the present invention, each pixel board comprises 8 pixels.

According to yet another aspect of the present invention, each pixel board comprises each pixel board comprises a horizontal group of 8 pixels sharing mounting hardware, power supply circuitry, and a RS485 receiver.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements within selected drawings may be illustrated not-to-scale, for illustrative clarity. The cross-sectional views, if any, presented herein may be in the form of “slices,” or “near-sighted” cross-sectional views, omitting certain background lines which would otherwise be visible in a true cross-sectional view, for illustrative clarity.

The structure, operation, and advantages of the present preferred embodiment of the invention will become further apparent upon consideration of the following description taken in conjunction with the accompanying drawings, wherein:

FIG. 1 is a block diagram of a conventional matrix sign display divided into two distinct sections.

FIG. 2 is a block diagram of a conventional panel of a matrix sign display.

FIG. 3A is a view of a conventional LED pixel board for a matrix sign display.

FIG. 3B is a block diagram of a conventional LED pixel board for a matrix sign display.

FIG. 4 is a block diagram of a conventional computer interface for a matrix sign display.

FIG. 5 is a block diagram of a conventional matrix sign display system.

FIG. 6 is a block diagram of a matrix sign system in accordance with the present invention.

FIG. 7 is a schematic representation of a pixel board for use with the present invention.

### DETAILED DESCRIPTION OF AN EXAMPLE EMBODIMENT OF THE PRESENT INVENTION

The discussion hereinbelow is directed to a conventional airship-based sign application wherein a full-color LED sign display may be mounted on an envelope (outer skin) of a lighter-than-air craft (blimp). The sign may be divided into eight logical panels, each comprising 480 LED pixel boards arranged on a grid 16 positions wide by 60 positions high. The LED pixel boards may be arranged in an interleaved checkerboard pattern, with alternating positions empty. In effect, each vertical column of each panel may comprise 30 LED pixel boards, and the panel may be considered as organized logically in a 16 by 30 array of LED boards. Each logical panel may have dedicated circuitry associated with it. In all, there may be 128 horizontal positions and 60 vertical positions, with only half of the positions populated. In one conventional system, two end columns may not be populated with LED pixel boards, providing a display with only 126 horizontal positions. The airship (blimp) on which the display is mounted may have two aircraft engines. In addition to providing propulsion for the airship, each engine may generate 28-volt DC power that may be used to power the conventional sign display.

The airship display described herein may have two modes of operation: a day mode and a night mode. In the day mode, a large number of high-intensity LEDs may be used in a simple bi-level “on-off” mode of operation to provide bright animated text and logo displays. At night, red, green, and blue triads of LEDs may be employed to display full-color “photographic” images and video. The night mode may not be effective during daylight hours since the ambient light and the colors on the envelope of the airship may prevent display of a viable “black” background when pixels are not illuminated, thereby providing extremely poor image contrast. The day mode display may have fewer pixels than the night mode, so only some of the LED pixel boards may be populated with day mode LEDs and driver circuitry.

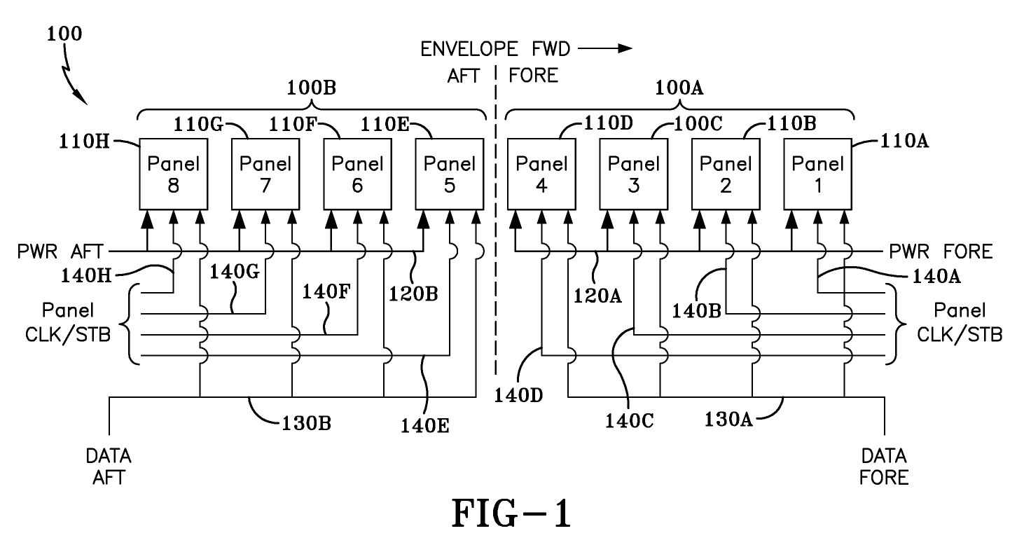

Those of ordinary skill in the art will understand that the conventional techniques hereinbelow may have broader applicability than the specific airship application shown and described with respect to FIGS. 1-5, and that the conventional techniques may be readily adapted to land-based sign systems with differing numbers of power sources. One conventional technique has improved power distribution in an LED matrix display sign by dividing the sign into two distinct sections, each section powered separately by a corresponding power source.

This reduces the total amount of current required from each power source, such as power generated separately by each of two aircraft engines, because the power from both sources may be utilized without combining into a single power source. If a display sign were powered by only a single power source, then may either be necessary to limit the display sign's power usage to the power available from one of the power sources alone, or to combine the two sources into a single higher capacity source using a high-power load sharing mechanism. Such mechanisms can be bulky and costly.

Further, the conventional technique may eliminate a significant bottleneck in communicating with a matrix sign display by providing a computer with a direct, bus-connected interface to the display sign. In effect, the local memory of the computer may be used as a display buffer. This may have the net effect of simultaneously reducing the complexity and bulk of sign display's support circuitry and of speeding up the process of writing to the sign by allowing the computer to communicate with the sign's computer interface at its full bus speed.

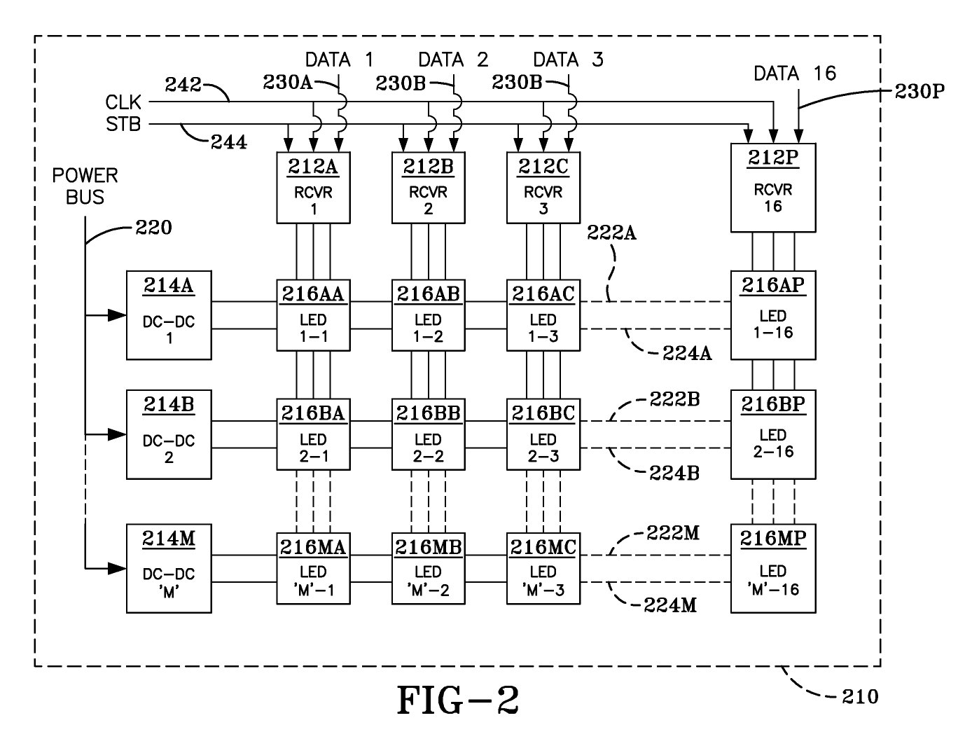

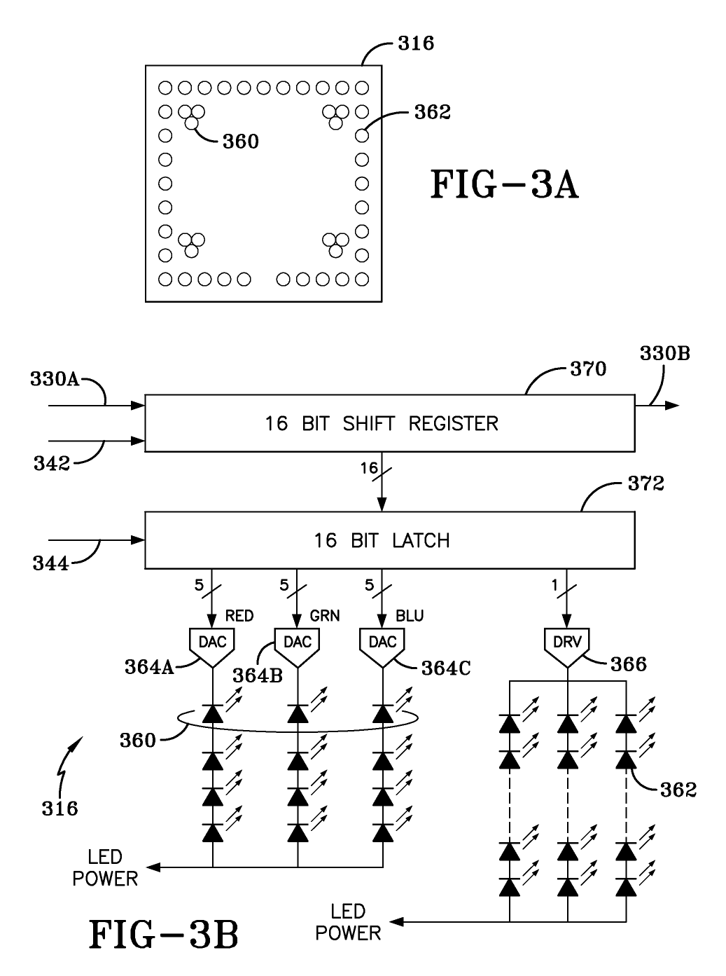

FIG. 1 is a block diagram of a conventional matrix sign display 100 divided into two sections, a “fore” section 100A and an “aft” section 100B. The display 100 may comprise eight panels, 110A, 110B, 110C, 110D, 110E, 110F, 110G and 110H, listed in order from front (fore) to back (aft). The “fore” section 100A may comprise the four frontmost panels 110A, 110B, 110C and 110D. The “aft” section 100B may comprise the four rearmost panels 110E, 110F, 110G and 110H. The panels 110A-D of the fore section 100A (PWR FORE) may be powered by a first power source 120A, and the panels 110E-H of the aft section 100B may be powered by a second power source 120B (PWR AFT). Each of the panels 110A-H may receive its own respective clock and strobe signal. In FIG. 1, panel clock/strobe signals 140A-H are indicated by single lines, but represent pairs of signals: a clock signal and a strobe signal. This is described in greater detail herein below with respect to FIGS. 2 and 3B. Data 130A for the fore section 100A of the sign display 100 may be provided in common to the four fore section panels 110A-D. Similarly, data 130B for the aft section 100B of the sign display 100 may provided in common to the four aft section panels 110E-H. Those of ordinary skill in the art will understand that it is possible to divide a sign display into more than two sign sections for powering by a like number of power sources and that the sign display 100 of FIG. 1 is a two-section example of this conventional technique.

FIG. 2 is a block diagram of a representative panel 210 (compare 110A-H, FIG. 1) of a matrix sign display system. The panel 210 may comprise an array of LED pixel boards 216AA-MP arranged in a 16 column×30 row logical array (e.g., 12 representative pixel boards of the 16×30 logical array are shown in FIG. 2). Each of the 16 columns may have a receiver 212A-P associated therewith. Each of the 30 rows may have a DC-DC converter 214A-M associated therewith. Each receiver 212A-P may receive a respective data bit signal 230A-P, which it may buffer and provide to all of the LED pixel boards in the column with which the receiver 212A-P is associated. The data path through the LED pixel boards 216AA-MP in any given column may be “daisy-chained” (e.g., each LED pixel board may have a data in and a data out signal). The data out signal of each LED pixel board 216AA-MP may be connected to the data in signal of the next sequential LED pixel board in the same column. The receivers 212A-P may all receive a panel clock signal 242 and a panel strobe signal 244 in common, and buffer these signals for distribution to the LED pixel boards 216AA-216MP in their respective columns.

Each DC-DC converter 214A-M may convert 28V “bulk” power from a power distribution bus 220 to 5V logic power and 15V LED power. This power may then be provided in parallel to each of the LED pixel boards 216AA-MP in the row with which the DC-DC converter is associated. By using a plurality of DC-DC converters for each logical panel 210, power efficiency may be maximized and the amount of power that must be supplied by any one converter 214‘x’ and the amount of local power dissipation by those converters may be kept at manageable levels. This may simplify the DC-DC converter circuitry, thereby permitting the use of inexpensive, standard components.

Those of ordinary skill in the art will understand that the number of DC-DC converters and the manner in which power is distributed to individual LED pixel boards may be determined on an application-dependent basis. It may not be necessary to limit the number of DC-DC converters to one per row per panel. It may also not be necessary to provide one converter per row per panel.

FIG. 3A is a view of a conventional LED pixel board 316 (compare 216AA-MP, FIG. 2) for the LED matrix sign display described hereinabove with respect to FIGS. 1 and 2. The LED pixel board 316 may comprise four “night mode” RGB triads 360 (one representative triad indicated in FIG. 3A), and a plurality of high-intensity “day mode” LEDs 362 arranged around the perimeter of the pixel board 316 (one representative “day mode” LED 362 indicated in FIG. 3A). On a pixel board intended for night mode only, the “day mode” LEDs 362 and any associated drive circuitry may be omitted.

FIG. 3B is a block diagram of circuitry associated with a conventional LED pixel board 316. A 16 bit shift register 370 may receive a data bit input 330A (compare 230A-P, FIG. 2) and a clock signal 342 (compare 242). Each time the clock signal 342 is pulsed, a bit may be shifted into the shift register 370. Each pulse of the clock signal 342 may shift in a new data bit value, moving the previously shifted bit into a next position in the register, ultimately appearing at a serial data output 330B of the shift register after 16 pulses.

The 16 bit contents of the shift register 370 may be presented as an input of a 16 bit latch 372. The latch 372 may receive a strobe signal 344. When a transfer pulse occurs in the strobe signal, the latch 372 may transfer data from its 16 inputs to its 16 outputs. As shown in the FIG. 3B, five of the output bits may be connected to an input of a first DAC (digital to analog converter) 364A, another five of the output bits may be connected to an input of a second DAC 364B, another five of the output bits may be connected to an input of a third DAC 364C, and one output bit may be connected to a “day mode” LED driver 366. When the bit connected to the day mode driver 366 is in an “on” state, the day mode driver may energize and illuminate the day mode LEDs 362 on the pixel board 316.

The first DAC 364A may control the illumination of red LEDs in the RGB triads 360, according to the 5 bit value at its input. The second DAC 364B may control the illumination of green LEDs in the RGB triads 360, according to the 5 bit value at its input. The third DAC 364C may control the illumination of blue LEDs in the RGB triads 360, according to the 5 bit value at its input. Each DAC may drive its associated color LEDs to any of 32 distinct intensity levels. Those of ordinary skill in the art will understand that the block diagram of FIG. 3B is highly schematic in nature and that there are many different possible ways of accomplishing this multi-intensity drive scheme. For example, the DACs 364B may accomplish their function by varying continuous LED current or by means of pulse width modulation.

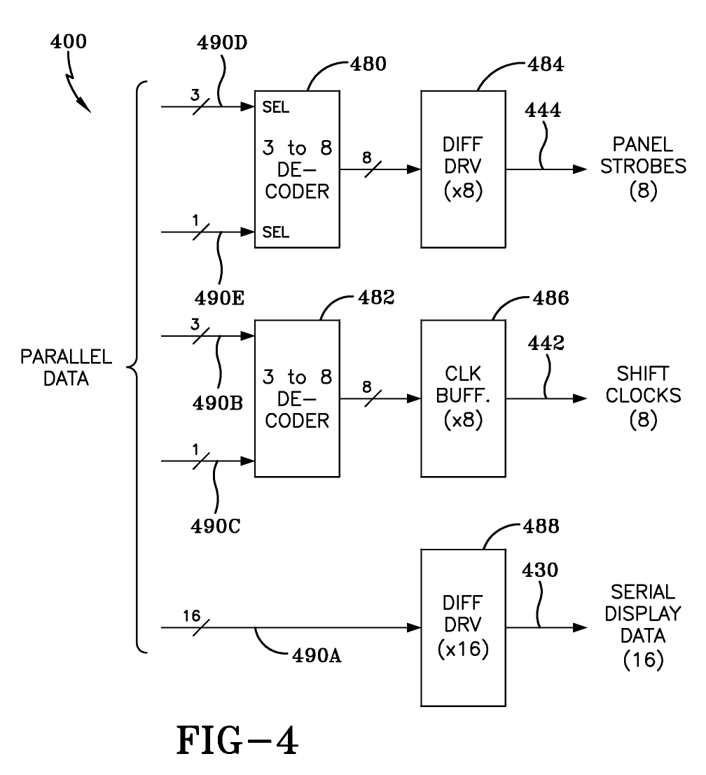

FIG. 4 is a block diagram of a computer interface 400 for the conventional matrix sign display system described hereinabove. 24-bit parallel data 490 may be received from a computer output register. A 16-bit portion 490A of the parallel data 490 may be buffered by differential drivers 488 to provide serial display data 430 for transmission to 8 logical display panels. Although FIG. 1 shows the data for the “fore” section 100A and aft section 100B of the sign display 100 as having separate data signals 130A and 130B, both may be commonly connected. One bit 490C of the parallel data 490 may be used to enable a 3-to-8 decoder 482, and three bits 490B of the parallel data 490 may be used as selector inputs to the decoder 482. Eight output lines from the decoder may be buffered by clock buffers 486 and may be presented to the logical panels as shift clocks. By identifying a logical panel number with the three selector bits 490B and by pulsing the associated enable bit 490C, a shift clock pulse may be transmitted to the identified logical panel (see FIGS. 2 and 3B), shifting the 16 bit serial display data 430, with one serial data bit applied to each of the columns of the logical panel. Similarly, one bit 490E of the parallel data 490E may enable input to another 3-to-8 decoder 480 and three bits 490D of the parallel data 490 may be used as selector bits. Eight output lines from the 3-to-8 decoder 480 may be buffered by differential drivers 484 and presented to the eight logical panels as panel strobes. By identifying a logical panel on the selector bits 490D and pulsing the enable bit 490E, a strobe pulse may be transmitted to the identified panel, transferring shifted data from pixel shift registers to the pixel latch for display (see FIGS. 2 and 3B).

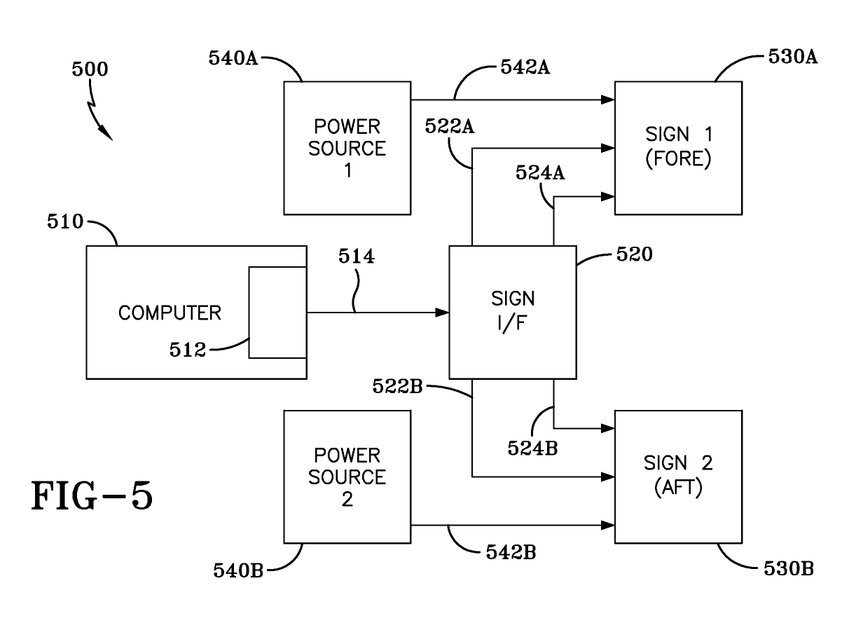

FIG. 5 is a block diagram of a conventional matrix sign display system 500 of the type described hereinabove, wherein a computer 510 having a bus-connected parallel output register 512 may connect to a sign interface 520 (compare 400) to control two sign sections 530A and 530B (compare 100A, 100B). The sign interface 520 may buffer and provide serial display data 526 (compare 430) to the two sign sections 530A and 530B. The sign interface 520 may also buffer clock signals 522A and buffered strobe signals 524A to the first sign section 530A, and buffered clock signals 522B and buffered strobe signals 524B to the second sign section 530B. A first power source 540A (e.g., generator, battery, etc.) may power the first sign section 530A via a first power bus 542A. A second power source 540B may power the second sign section 530B via a second power bus 542B.

To control the conventional display system, the computer may build frame images to be displayed, then directly accesses the display via the interface mechanism described hereinabove with respect to FIG. 4. The panel may be analyzed for bit position and organized onto the data bus according to the arrangement of pixels in the display and the desired intensity value(s), then shifted into the appropriate pixels by identifying panels and generating panel clock signals. For each panel, 480 shifts may be required, since there are 30 pixels in each column, and 16 bits of pixel data associated with each pixel. Shifted-in data may be transferred from the shift registers to the display by generating panel strobes in the manner described above.

Panel data, clocks, and strobes may be generated under direct program control, or the pattern of data, clocks, and strobes may be pre-formulated into a memory buffer and transferred to the display using a timer-driven DMA (direct memory access) scheme. In either case, the interface delay may be minimal in this scheme due to the direct bus-connected nature of the sign interface. Further, interface circuitry may be minimized by eliminating a separate display memory and sign scanner function and allowing the computer to provide these functions directly by using its own memory for display image storage and by generating the scanning clock and strobe signals under the program (and/or DMA) control.

A system in accordance with the present invention may effectively provide an Aerial HDTV-like display with brilliant day and night visible color capabilities. The modularity of the system may allow for the installation of different size and placement on various airship/blimp platforms. Two limiting factors in a conventional design of an airship aerial LED display are power and weight constraints. These constraints may require the use of highly efficient super bright LEDs coupled with highly integrated control and lightweight materials.

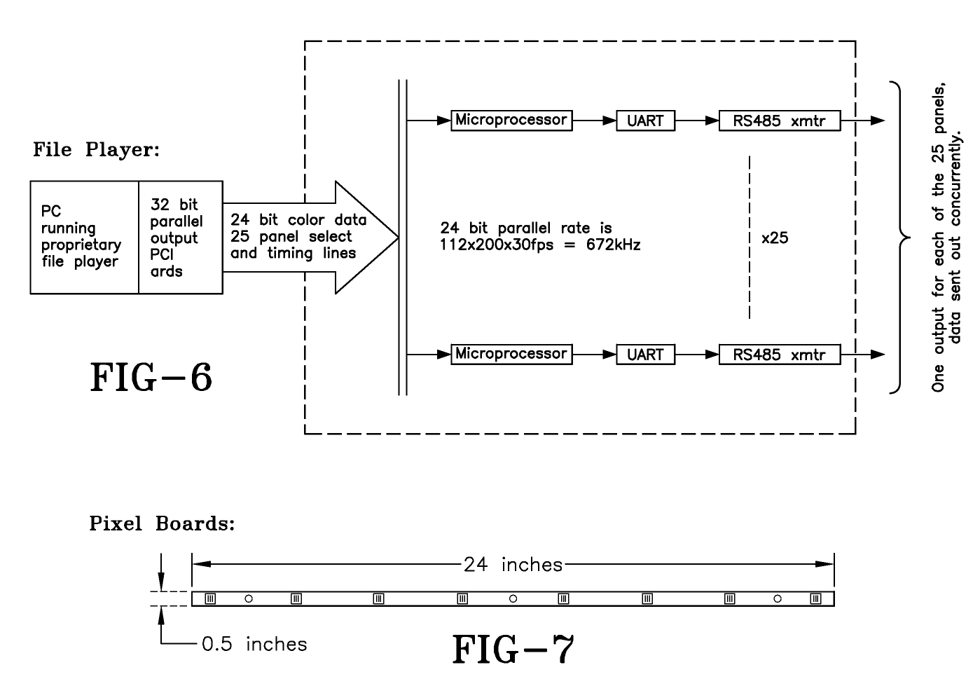

LED sign requirements may be improved by LED sign resolution, HD type formats (e.g., 16×9), increase in pixel count, daylight visible color animation and video, reduced equipment weight, improved color depth (e.g., 24 bit+), improved viewing distance and angle, improved reliability, and efficient field maintenance requirements. In accordance with the present invention, the system may utilize software for allowing a computer (e.g., a PC) outfitted with parallel output ports to play graphics files in a specified format (FIG. 6). The output ports of the computer may send pixel data to a hardware pixel driver interface that may send the color data concurrently to as many as 25 segments of a sign or panel. This system may thus allow the use of microprocessors, universal asynchronous receiver/transmitters (UARTs), and low-EMI RS485 data transmission techniques to distribute color data to as many as 25 segments of a sign or panel. Pixels may be organized as horizontal groups of 8 pixels on a single circuit board, on 3.25 inches mounting centers (FIG. 7). The 8 pixels may thereby allow sharing of the mounting, power supply circuitry, and RS485 receiver. Each pixel position may be made up of one RGB LED cluster. Pixel boards may be mounted using small standoffs mounted to the side of the airship, angled for best viewing.

Further, the system of the present invention may have no memory buffering or serial data being distributed by shift registers. The power distribution may be different also, with the only one similarity being a forward and aft harness. The harness may use four wires per column, two for data and two for power. Thus, a microcontroller based design with an eight single RGB LEDs per pixel may be mounted on a strip having eight pixels each, instead of 12 individual RGB LEDs per pixel. The matte size may now be modular with two major sizes of 144×86 and 200×112. The system may further allow for smaller or larger signs.

The system of the present invention may be modular such that the system may be used on airships with different available power levels and physical characteristics. For optimal daytime viewing, the matte background for the sign may be black. The pixel board solder mask may also be black. The dark background may provide better contrast for daytime viewing.

The player software of the system may allow a PC outfitted with fast parallel output ports to play graphics files in a specified format. The PC output ports may send the pixel data to a hardware pixel driver interface that may send the color data concurrently to as many as 25 segments, or panels, of the sign. The system may allow low-EMI RS485 data transmission techniques to distribute color data to the pixels.

The pixels may be organized as horizontal groups of 8 pixels on a single circuit board, on 3.25 inch mounting centers. This may allow 8 pixels to share the mounting, power supply circuitry, and RS485 receiver. Each pixel position may comprise one RGB LED cluster. The pixel boards may be mounted using small standoffs mounted to the side of the airship, angled for best viewing. Alternatively, the angled mounts may be fastened to fabric, if banner-style mounting is desired.

One example pixel arrangement may be:

86 pixels High×144 pixels Wide=12,384 pixels;
Pixels may appear on 3.25″ Horizontal and Vertical centers;
Mat size may be 23.3 feet High×39.0 feet Wide;
Aspect ratio may be 1.67:1 (approx 16:9);
Eight pixels may be built onto a narrow horizontal pixel board;
Pixel boards may be mounted to the angled standoffs;
Horizontal row: 144 pixels Wide/8 Pixels per pixel board=18 pixel boards Wide; Vertical column: 86 pixel boards High;
Number of pixel boards: 86 High×18 Wide=1548; and
Each pixel position may comprise one RGB LED cluster.

Another example pixel arrangement may be:

112 pixels High×200 pixels Wide=22,400 pixels;
Pixels may appear on 3.25″ Horizontal and Vertical centers;
Mat size may be 30.3 feet High×54.2 feet Wide;
Aspect ratio may be 1.79:1 (approx 16:9);
Eight pixels may be built onto a narrow horizontal pixel board;
Pixel boards may be mounted to the angled standoffs;
Horizontal row: 200 pixels Wide/8 pixels per pixel board=25 pixel boards Wide;
Vertical column: 112 pixel boards High;
Number of pixel boards: 112 High×25 Wide=2800; and
Each pixel position may comprise one RGB LED cluster.

The quantity of pixels may be limited by the amount of power available from an airship's generators. This, in turn, may affect the height and width of the sign while attempting to maintain the desired 16:9 format. An example estimate of the amount of power required by each pixel board may be 28Vdc×0.100 amps=2.8 watts. This value may determine how many pixel boards may be driven by the available power sources (e.g., the size of the sign).

When distributed to the pixel boards, the incoming 28Vdc power may run through a small on-board switching power supply to convert the power to the 5Vdc for the pixel board. This switching power supply may run at 90% efficiency. Power available on the pixel board after the 5Vdc output switcher may be 2.8 Watts×90% Efficiency=2.52 watts. The overhead circuitry on the pixel board may be allocated at 0.12 watts, allowing 2.40 watts for the LEDs. At 5Vdc, this may be 0.48 amps. The LED forward voltages and their corresponding current sources may require 5Vdc. Each of the 24 LEDs on a pixel board (8 pixels×3 LEDs per cluster) may then be permitted to draw 20.0 ma (when On at 100% PWM; 0.48 amps/24 LEDs=0.020 amps/LED).

Power available from an airship generator may be, for example, 160 amps×28Vdc=4480 watts. This power may be budgeted evenly over the pixel boards (e.g., 4480 watts/2.8 watts per pixel board=1600 pixel boards maximum). As another example, power available from an airship generator may be 285.7 amps×28Vdc=8000 watts. This power may be budgeted evenly over the pixel boards (e.g., 8000 watts/2.8 watts per pixel board=2857 pixel boards maximum).

The frame rate of the system may be set by the player software to 30 frames per second, with each frame being updated every 33.3 msec. During the frame time, the PC may send frame data through parallel ports to the pixel driver interface in a parallel 24-bit color format, directing the data to the correct microprocessor for each panel. This data may be loaded into the microprocessors on an interrupt basis. The microprocessors may then send the color data to the pixel boards in their corresponding panels.

A large sign may set a timing standard for data transmission rates. A smaller sign may be updated at the same rate. One vertical column of 112 pixel boards may comprise a panel. Thus, there may be 112×8=896 pixels in each panel, with a total of 25 adjacent panels making up the entire sign. The video data may be distributed concurrently to each of the 25 panels, but each panel may only receive the data that that panel requires. The system may minimize transmission data rates required to update the entire sign in one frame time.

Within a 33.3 msec frame time, the player PC may begin loading the frame data into the microprocessors in the pixel driver interface. The microprocessors may immediately begin to update each of their panels containing 896 pixels. Each 24 bit pixel color may require 30 bits sent over the RS485/UART system, 896 pixels×30 bits/pixel=26,880 bits, 26,880 bits/33.3 msec =807 kbaud rate. The baud rate for the data transmission to each panel may thereby be 807 kbaud minimum to update a sign at 30 frames per second, using 24 bit color.

Data may be distributed vertically from the pixel driver interface to the pixel boards in each panel and thus to the pixels over an RS485 4-wire system: +/−28Vdc, A, and B. Receivers on the pixel driver boards may be quarter-load rated to observe loading rules on the 4-wire 112-member panel bus. If a receiver on a pixel board determines that the received data for a pixel is bad (such as; no start bit, no stop bit, framing error, etc.), the receiver may reject the data and continue to display the existing color number for that pixel. The data may be updated upon correct reception of the color data in the next frame.

Before installation on the sign, pixel boards may be programmed with the row number where pixel board may be mounted. This may be required for the pixel board to acquire color data for its eight pixels from the local panel network and reject data intended for one of the other 112 pixel boards in the panel. A handheld programmer may perform this task easily at the hanger or in the field. The handheld programmer may also be used to send test commands to the pixel board.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A high-visibility display system comprising:
two or more sign sections with each sign section being supplied with display data by a single computer transmitting the display data concurrently.

2. The system as set forth in claim 1 further including a pixel driver interface with an output port for each sign section.

3. The system as set forth in claim 2 wherein the pixel driver interface includes a microprocessor for each sign section.

4. The system as set forth in claim 3 wherein the pixel driver interface includes a universal asynchronous receiver/transmitter for each sign section.

5. The system as set forth in claim 4 wherein the pixel driver interface includes a RS485 communication module for each sign section.

6. The system as set forth in claim 5 wherein the computer includes a fast parallel output port for playing graphics in a predetermined format.

7. The system as set forth in claim 1 further including a plurality of pixel boards, each pixel board comprising one RGB LED cluster.

8. The system as set forth in claim 1 wherein each pixel board comprises 8 pixels.

9. The system as set forth in claim 7 wherein each pixel board comprises 8 pixels.

10. The system as set forth in claim 9 wherein each pixel board comprises each pixel board comprises a horizontal group of 8 pixels on a single circuit board.

11. The system as set forth in claim 10 wherein each horizontal group of 8 pixels shares mounting hardware, power supply circuitry, and a RS485 receiver.

12. A high-visibility display sign comprising:
two or more sign sections supplied with display data by a single computer transmitting the display data concurrently to each sign section; and
a pixel driver interface with an output port for each sign section.

13. The sign as set forth in claim 12 wherein the pixel driver interface includes a microprocessor for each sign section.

14. The system as set forth in claim 13 wherein the pixel driver interface includes a universal asynchronous receiver/transmitter for each sign section.

15. The system as set forth in claim 14 wherein the pixel driver interface includes a RS485 communication module for each sign section.

16. The system as set forth in claim 15 wherein the computer includes a fast parallel output port for playing graphics in a predetermined format.

17. The system as set forth in claim 12 further including a plurality of pixel boards, each pixel board comprising one RGB LED cluster.

18. The system as set forth in claim 12 wherein each pixel board comprises 8 pixels.

19. The system as set forth in claim 17 wherein each pixel board comprises 8 pixels.

20. The system as set forth in claim 19 wherein each pixel board comprises each pixel board comprises a horizontal group of 8 pixels sharing mounting hardware, power supply circuitry, and a RS485 receiver.
